(19) United States
(12) Patent Application Publication
(10) Pub. No.: US 2008/0091631 A1
(43) Pub. Date: Apr. 17, 2008

(54) Method and Apparatus for an Algorithmic Approach to Patient-Driven Computer-Assisted Diagnosis

(76) Inventors: Henry Joseph Legere, Malden, MA (US); Nicholas Aaron Solter, Colorado Springs, CO (US)

Correspondence Address: NICHOLAS SOLTER, 13010 ROCKBRIDGE CIRCLE, COLORADO SPRINGS, CO, 80921, US

(21) Appl. No.: 11/869,292

(22) Filed: Oct. 9, 2007

Related U.S. Application Data
(60) Provisional application No. 60/829,089, filed on Oct. 11, 2006.

(51) Int. Cl. G06N 5/02

(52) U.S. Cl. 706/46

(57) ABSTRACT

One embodiment of the present invention provides a computer software medical diagnosis system with which users can interact over the Internet using a web browser in order to obtain a medical diagnosis or recommendation. The user interacts with the diagnosis system by first identifying his or her chief complaint, and then answering a series of questions about his or her current symptoms, medical history, identification (age, sex, race), and the like. Then the diagnosis system presents him or her with a diagnosis or recommendation.

This application claims the benefit of U.S. Provisional Application No. 60/829,089 filed Oct. 11, 2006.

### DESCRIPTION

1. Field of the Invention

The present invention relates to the field of computer-assisted medical diagnosis, and, more specifically, to an algorithmic approach to patient-driven computer-aided diagnosis.

2. Related Art

The diagnosis of a patient's illness is a complex activity in which a physician or medical professional aggregates information from the patient's statements and answers to questions, the patient's health history, physical findings, lab results, and other sources. The physician uses his or her expertise and medical training to reach a conclusion about the source of the patient's ailments.

The idea of computer-assisted diagnosis has become popular for several reasons, among them the scarcity of physicians, the perceived mistakes of medical professionals, the growing ubiquity of computers, and the perceived infallibility of computers. The “holy grail” of computer-assisted diagnosis is a system with which a user can interact with the computer to obtain a diagnosis without the presence or assistance of a medical professional.

There has been much diverse research in the field of computer-assisted diagnosis. The traditional “expert system” approach to computer-assisted diagnostic systems is to assemble a database of diseases and findings and to connect them with probabilities. For example, the Internist-1 system uses three variables: evoking strength, frequency, and import (Miller, R. A., Pople, H. E., Jr., Myers, J. D.: Internist I, An Experimental Computer-Based Diagnostic Consultant for General Internal Medicine. The New England Journal of Medicine, 307:468-476, 1982). The evoking strength specifies the likelihood that a disease is the cause of a finding, while the frequency specifies the opposite (how often a finding is associated with a disease). The import describes the importance of the finding. The diagnosis algorithm employs these variables to determine which disease best explains the specified findings.

There are two main problems with this probabilistic approach. First, it's not how medicine actually works. Symptoms do not exist in isolation, combinations of symptoms can lead to results not predicted by the presence of the individual symptoms, and multiple symptoms are sometimes caused by two or more independent diseases. For example, probabilistic approaches typically over-diagnose multi-system diseases such as lupus because they naively assume that a single condition must be causing all symptoms.

The second problem with the expert system approach is that it's not how physicians actually diagnose patients. Although it may not be written down formally, the process of diagnosis by a medical professional typically follows a “decision tree” or “decision algorithm.” The physician usually starts with a differential diagnosis of possible diseases. Then he or she narrows it down with a series of questions, physical findings, or lab results until a single result is reached. For example, if a patient complains of cough, a probabilistic diagnosis approach might say that she has a small probability of lung cancer. However, that's just the start of most physician diagnoses. A doctor might include lung cancer in the differential diagnosis, but with a few quick follow-up questions about recent weight loss, history of smoking, etc., easily rule it out or move it to the top of the list. The probabilistic approach doesn't allow for these kinds of follow-up questions.

Thus, a more accurate approach to computer-assisted diagnosis would be to formalize the decision algorithms used by physicians and let a computer run them. This approach is much more labor-intensive than is the probabilistic approach, because it doesn't allow the computer to extrapolate or make inferences based on probabilities. Instead, every decision point must be explicitly encoded as part of a decision tree generated by a physician. However, it better emulates the way doctors actually work, and therefore should give more accurate results.

### SUMMARY OF THE INVENTION

One embodiment of the present invention provides a computer software medical diagnosis system with which users can interact over the Internet using a web browser in order to obtain a medical diagnosis or recommendation. The user interacts with the diagnosis system by first identifying his or her chief complaint, and then answering a series of questions about his or her current symptoms, medical history, identification (age, sex, race), and the like. Then the diagnosis system presents him or her with a diagnosis or recommendation.

This embodiment uses medical diagnosis trees, called diagnosis algorithms. These diagnosis algorithms contain several different types of decision points, each of which requires answers from the user for one or more questions. Individual diagnosis algorithms may reference other diagnosis algorithms. The diagnosis algorithms are stored as XML-structured text in a relational database.

This embodiment does not employ live medical professionals. Instead of using physical findings in the decision making process, the diagnosis system asks the user questions to emulate these findings.

This embodiment is implemented on a computer system in an object-oriented programming language. The algorithm decision points are represented by instances of the DecisionNode class or its subclasses, and the algorithm questions are represented by instances of the Question class or its subclasses. The representation of each algorithm takes the form of a directed, acyclic graph (DAG), and contains a “root” node, which is the starting point of that algorithm.

In this embodiment, the Diagnosis Engine component initiates a diagnosis by querying for the chief complaint from the user, retrieving from the diagnosis algorithm database the root decision node for the algorithm representing that chief complaint and pushing it onto a “to-visit” stack of decision nodes. The Diagnosis Engine runs the diagnosis with a depth-first traversal of the diagnosis algorithm, using the to-visit stack. The diagnosis queue allows the Diagnosis Engine to collect multiple possible diagnoses to display to the user simultaneously after the algorithm terminates. The diagnosis terminates if there are no more nodes in the to-visit stack, or if it reaches a terminal node.

In a variation on this embodiment, the Diagnosis Engine can “auto-fill” answers to diagnosis algorithm questions from the user's electronic medical record, or from stored answers to previous questions in the diagnosis.

### DESCRIPTION OF DRAWINGS

Exemplary embodiments of the invention will be described with reference to the accompanying drawings. Like items in the drawings are shown with the same reference numbers. Embodiments of the invention are illustrated by way of example, and not by way of limitation, in the figures of the accompanying drawings.

FIG. 1 is a block diagram depicting the computer-assisted diagnosis according to an embodiment.

FIG. 2 is a flow diagram depicting the computer-assisted diagnosis according to an embodiment.

FIG. 3 and FIG. 4 are flow diagrams depicting part of a diagnosis algorithm according to an embodiment.

FIG. 5 is a block diagram depicting a computer system implementing the computer-assisted diagnosis according to an embodiment.

FIG. 6 is a block diagram depicting a class hierarchy of questions according to an embodiment.

FIG. 7 is a block diagram depicting a class hierarchy of decision nodes according to an embodiment.

FIG. 8 and FIG. 9 are flow diagrams depicting the representation of part of an algorithm by DiagnosisNode and Question objects according to an embodiment.

FIG. 10 is a flow diagram depicting the operation of the Diagnosis Engine according to an embodiment.

### DETAILED DESCRIPTION OF THE INVENTION

In the following description, numerous specific details are set forth in order to provide a thorough understanding of the present invention and to enable any person skilled in the art to make and use the invention. In some instances, well-known features have not been described in detail to avoid unnecessarily obscuring the present invention. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Various aspects and features of example embodiments of the invention are described in more detail hereinafter in the following sections: (1) Functional Overview; (2) Diagnosis Algorithms; (3) Implementation; (4) Variations.

### Functional Overview

One or more embodiments of the invention relate to a computer software medical diagnosis system with which users can interact in order to obtain a medical diagnosis or recommendation. The diagnosis system works by asking the user a series of questions, after which it arrives at a diagnosis, conclusion, or recommendation for the user.

In one or more embodiments of the invention, the user initiates the interaction with the diagnosis system by identifying his or her chief complaint. As used herein, the term “chief complaint” follows the commonly accepted definition of the term among medical professionals, and is synonymous with the terms “primary complaint,” “primary symptom,” and “presenting complaint.” Examples of a chief complaint include “cough” and “fever.”

In one or more embodiments of the invention, after specifying his or her chief complaint, the user answers a series of questions about his or her current symptoms, medical history, identification (age, sex, race), and the like. Those skilled in the art will appreciate that these questions may take other forms, and the invention is not limited to any particular type of question.

In one or more embodiments of the invention, after the user answers a series of questions, the diagnosis system presents him or her with a diagnosis or recommendation.

In one or more embodiments of the invention, the interaction between the user and the diagnosis program emulates a physician-patient relationship, but does not involve a live physician. Instead, the diagnosis software relies on a database of medical information. However, those skilled in the art will appreciate that the user could in fact be a medical professional operating the diagnosis program in the process of diagnosing a patient.

In one or more embodiments of the invention, the medical information takes the form of diagnosis decision trees, herein referred to as “diagnosis algorithms.”

In one or more embodiments of the invention, the user interacts with the diagnosis system over the Internet. The diagnosis system itself runs on a server attached to the Internet, and the user interacts with the server over the World Wide Web through his or her web browser. Those skilled in the art will appreciate that this interaction may take other forms, including a user interacting with the diagnosis system through input/output devices connected directly to the diagnosis system, a user interacting with the diagnosis system on a hand-held computer, and the like. The invention is not limited to a particular medium of interaction.

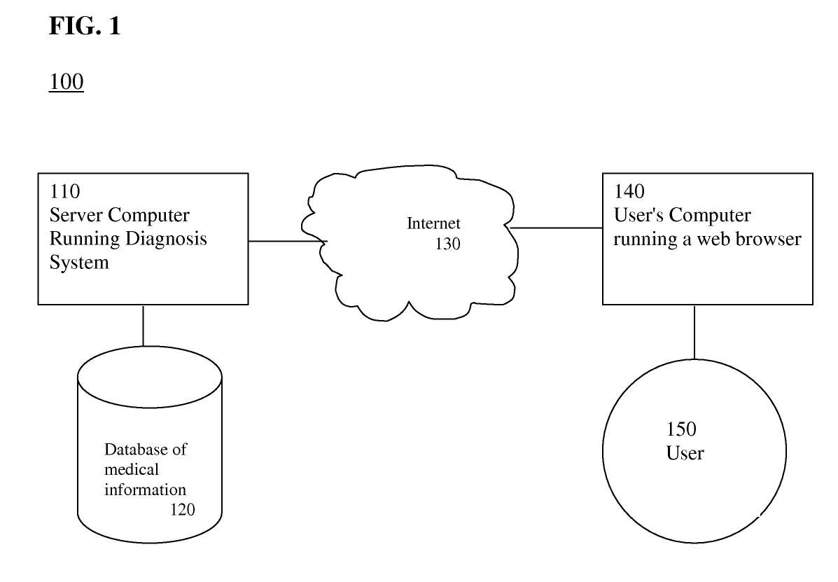

FIG. 1 is a block diagram, 100, of a user interacting with the diagnosis software in accordance with one or more embodiments of the present invention. A user, 150, accesses the diagnosis functionality through a web browser running on his or her computer, 140. The user's web browser contacts the diagnosis program running on the server computer, 110, through the Internet, 130. The server computer accesses a database of medical information, 120.

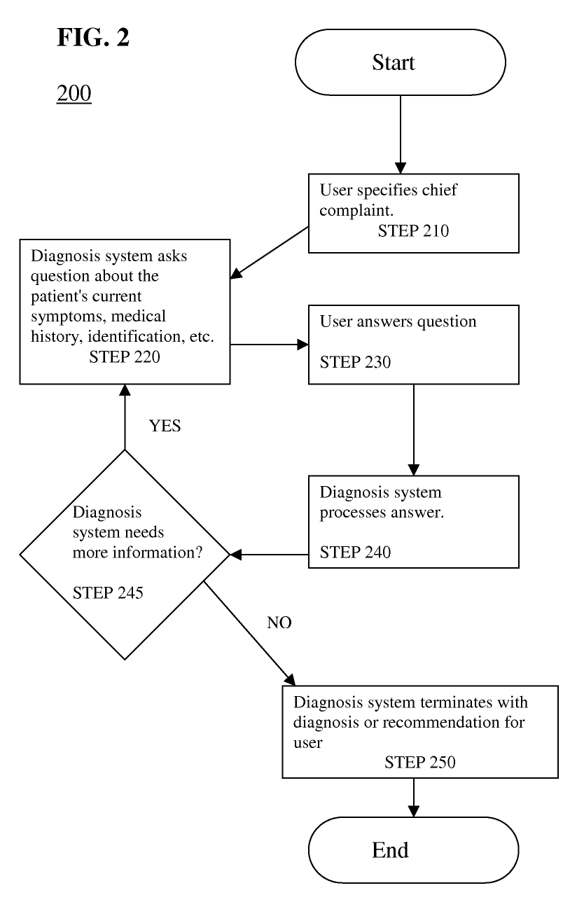

The diagnosis program just described is now described with reference to a flow diagram 200 of FIG. 2. A user specifies a chief complaint in STEP 210. The diagnosis system asks the user a question in STEP 220. The user answers the question in STEP 230 and the diagnosis system processes the answer in STEP 240. If the diagnosis system needs more information in STEP 245, it returns to STEP 220. If the diagnosis system has enough information for a diagnosis or recommendation it conveys that conclusion to the user in STEP 250.

### Diagnosis Algorithms

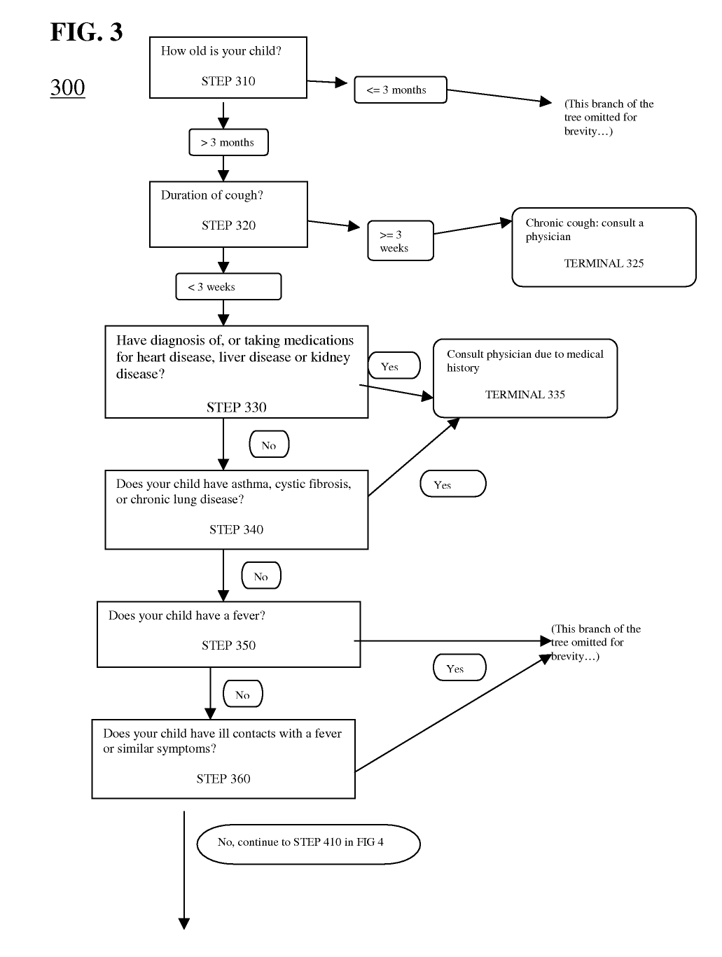

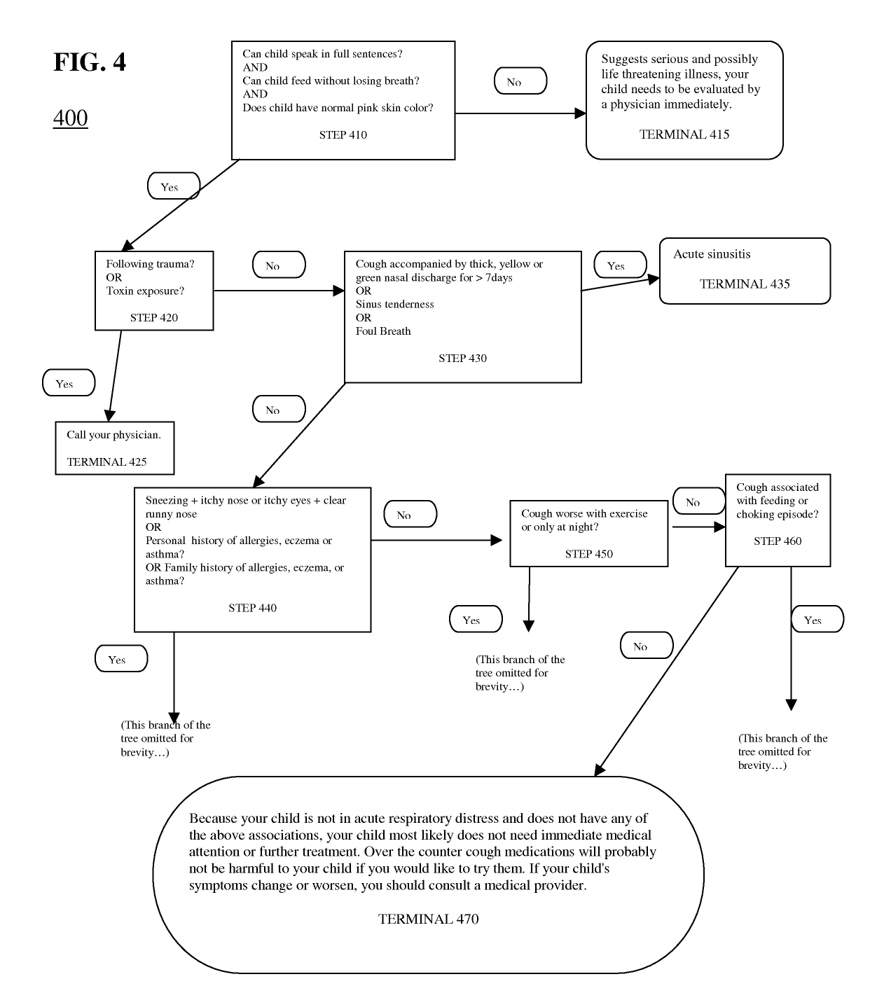

FIG. 3 and FIG. 4 together are a flow diagram in accordance with one or more embodiments of the invention that show part of a pediatric diagnosis algorithm for the chief complaint of cough. Decision points are marked as STEP X, where X is a unique number. Terminal points are marked as TERMINAL X where X is a unique number.

In one or more embodiments of the invention, the diagnosis algorithms consist of several different types of decision points. Each decision point requires user answers to one or several questions. Example types of decision points, with reference to FIG. 3 and FIG. 4, include, but are not limited to,
Age
   One or more branches based on the patient's age.
   Example: STEP 310 in FIG. 3 (“How old is your child?”)
Symptom presence
   Binary decision point based on presence or absence of a symptom
   Example: STEP 350 in FIG. 3 (“Does your child have a fever?”)
Symptom duration
   One or more branches based on the symptom duration
   Example: STEP 320 in FIG. 3 (“Duration of cough?”)
Medical history
   Binary decision point based on past medical history
   Example: STEP 330 in FIG. 3 (“Have diagnosis of, or taking medications for, . . . ?”)
Physical finding
   Binary decision point based on a patient-reported physical finding
   Example: STEP 410 in FIG. 4 (“Does child have normal pink skin color?”)
General history
   Binary decision point based on patient's history
   Example: STEP 420 in FIG. 4 (“Following trauma OR recent toxin exposure?”)
Symptom details
   Binary decision point based on further details about a present symptom
   Example: STEP 450 in FIG. 4 (“Cough worse with exercise or only at night?)
Family history
   Binary decision point based on family member's medical history
   Example: STEP 440 in FIG. 4 (“Family history of allergies . . . ?)

Those skilled in the art will appreciate that these decision points may take other forms, and the invention is not limited to any particular diagnosis algorithm decision points.

As described above, in one or more embodiments of the invention, the user interaction with the diagnosis system does not involve a live physician. Thus, the diagnosis algorithms are unable to include decision points that depend on physical findings or lab results. However, the algorithms can determine information about what typically would be physical findings by use of appropriate questions. An example of this innovation is the final question in STEP 410 in FIG. 4 in the cough algorithm, “Does child have normal pink skin color?” Although the information requested in this particular decision point would generally be observed by a physician in the process of a physical exam, the question gives enough information for the non-medical professional user to answer it.

In one or more embodiments of the invention, if a diagnosis algorithm reaches a point at which it requires physical findings or lab results, it terminates with a recommendation that the user see a physician. If the algorithm reaches a point at which the patient would be considered to have a medical emergency, it terminates and directs the patient to see a physician as soon as possible. Examples include TERMINAL 325 in FIG. 3 and 415 in FIG. 4.

In one or more embodiments of the invention, the diagnosis algorithms contain diagnosis termination points. Examples include TERMINAL 435 in FIG. 4.

In one or more embodiments of the invention, the diagnosis algorithm contains recommendation termination points. Examples include TERMINAL 470 in FIG. 4.

In one or more embodiments of the invention, individual diagnosis algorithms may reference other diagnosis algorithms. For example, if the algorithm for the chief complaint of fever algorithm determines that a cough is present, it can specify that the flow of control should jump to the cough algorithm.

In one or more embodiments of the invention, the diagnosis algorithms are stored as XML-structured text in a relational database. However, those skilled in the art will appreciate that the storage format and database may take other forms, including pure text in flatfiles, object-oriented databases, and the like. The invention is not dependent on a specific storage format or mechanism.

### Implementation

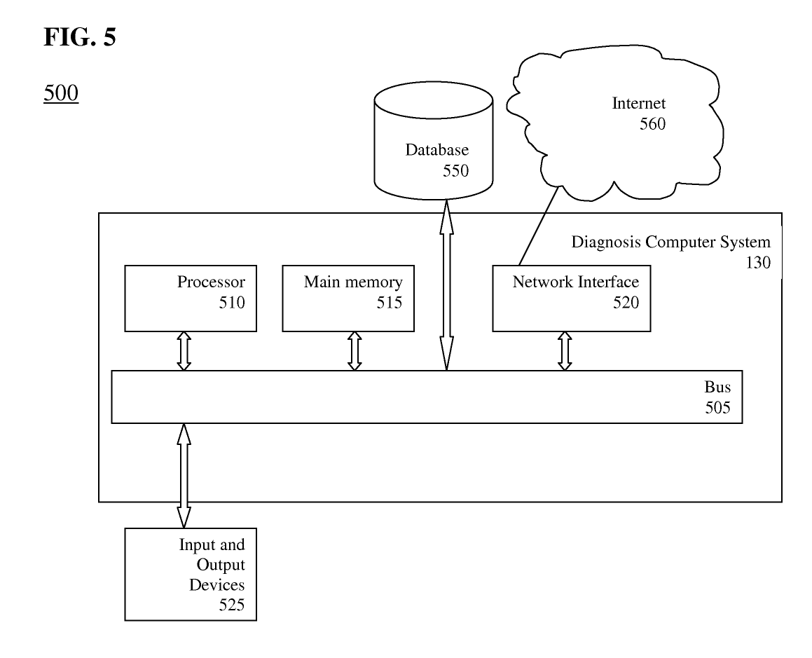

In one or more embodiments, the diagnosis system may be implemented on virtually any type of computer regardless of the platform being used. FIG. 5 shows a computer system 110 that implements the diagnosis software in accordance with one or more embodiments of the invention. This computer system includes a processor 510, associated memory 515, a bus or other communication mechanism 505, a network interface 520, a database 550, and numerous other elements and functionalities typical of today's computers (not all of which are shown).

In one or more embodiments of the invention, the diagnosis system is implemented in an object-oriented programming language.

In one or more embodiments of the invention, there is a distinct separation between the decision points of the diagnosis algorithm and the actual questions asked at those decision points. The questions handle the details of formatting a question and response form and processing the user's answer. The decision points handle the logic of each decision point, each of which may be dependent on the answers to zero, one, or several questions.

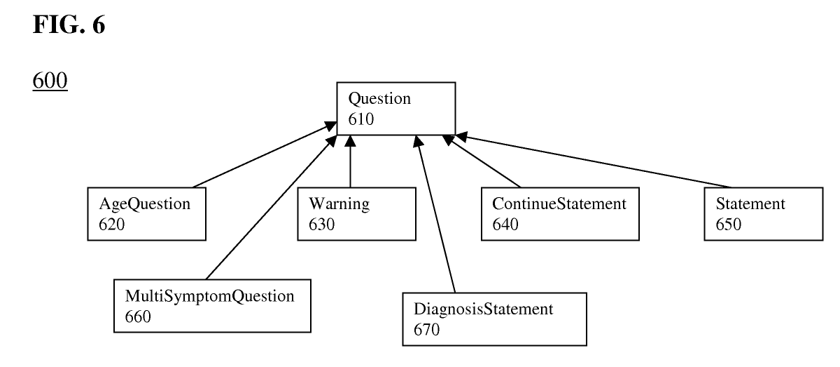

In one or more embodiments of the invention, the diagnosis system implementation contains a “question” abstraction to represent interactions with the user. Each question or statement in the program is represented by an instance of the Question class or one of its subclasses. FIG. 6 shows a Question class hierarchy in accordance with one or more embodiments of the invention. The functionality of the questions, with reference to FIG. 6 is:
Question (610)
   Asks a yes/no question.
AgeQuestion (620)
   Ask's the user's age.
ContinueStatement (640)
   Unary question. Displays a non-terminal statement with a choice to continue.
DiagnosisStatement (670)
   Displays a diagnosis. Terminal (no choice to continue).
MultSymptomQuestion (660)
   Asks about multiple symptoms/diseases/disease history being present (yes/no) in a single question.
Statement (650)
   Displays a terminal statement.
Warning (630)
   Displays a warning (severe) statement. Terminal.

Those skilled in the art will appreciate that these questions may take other forms, and the invention is not limited to any specific question classes.

In one or more embodiments of the invention, The Question class and its subclasses handle all user interaction. The question instances know how to generate a question and response form in the correct user interface, how to parse the answer, and how to translate the answer into a result that the rest of the diagnosis program can use.

In one or more embodiments of the invention, the question instances generate questions and form responses in Hyper Text Markup Language (HTML).

In one or more embodiments, the Question class and its subclasses support at least the following interfaces:
generateQuestion( )
   Prints the question and the response form in HTML
processAnswer( )
   Parses the user's response from the form parameters.
getBinaryResult( )
   Returns true or false, for use by the containing DecisionNode (discussed below).

In one or more embodiments, the question subclasses can support additional interfaces to support non-binary and other special decision points. For example, the AgeQuestion class provides a public method GetAge( ) that can be used by the AgeDecisionNode (discussed below).

In one or more embodiments of the invention, each decision point in a diagnosis algorithm is represented as an instance of the DecisionNode class or one of its subclasses. The types of decision nodes are represented by a class hierarchy. Each DecisionNode instance is associated with one or more questions.

In one or more embodiments, not all decision points are binary. Some decision points have more than two possible branches. Additionally, some decision points have only a single branch (unary), or have no branches at all (terminal).

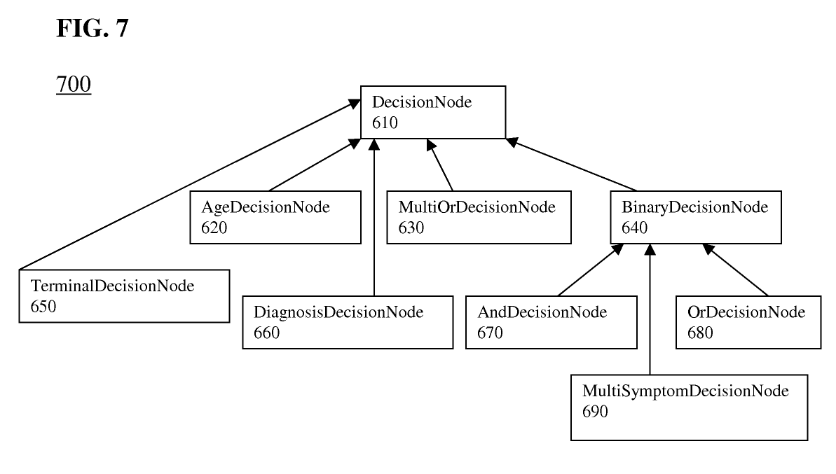

FIG. 7 shows the DecisionNode class hierarchy in accordance with one or more embodiments of the present invention. The functionality of the decision nodes, with reference to FIG. 7 is:
DecisionNode (610)
   Abstract superclass.
BinaryDecisionNode (640)
   Abstract superclass.
AgeDecisionNode (620)
   N-ary decision node depending on age. Associated with a single AgeQuestion.
AndDecisionNode (670)
   Binary decision point. One or more questions. If all are true, chooses “true” path. If any false, chooses “false” path. Associated with one or more Questions.
OrDecisionNode (680)
   Binary decision point. One or more questions. If any are true, chooses “true” path. If all are false, chooses “false” path. Associated with one or more Questions.
MultiOrDecisionNode (630)
   Like OrDecisionNode, but “true” path leads to multiple decision points that should be taken sequentially. Associated with one or more Questions.
MultiSymptomDecisionNode (690)
   A Binary decision point. Associated with one MultiSymptomQuestion.
DiagnosisDecisionNode (660)
   A terminal decision point with a diagnosis. Associated dynamically (during the running of the diagnosis algorithm) with one or more Diagnosis Statements.
TerminalDecisionNode (650)
   A terminal decision point without a diagnosis. Associated with one Statement or Warning.

Those skilled in the art will appreciate that these decision points may take other forms, and the invention is not limited to any specific decision points.

In one or more embodiments of the invention, the representation of each algorithm contains a “root” node, which is the starting point of that algorithm. The representations of the algorithms take the form of directed, acyclic graphs (DAGs). The nodes of the graph are represented by DecisionNode objects and the arcs of the graph are the possible branches from each decision node.

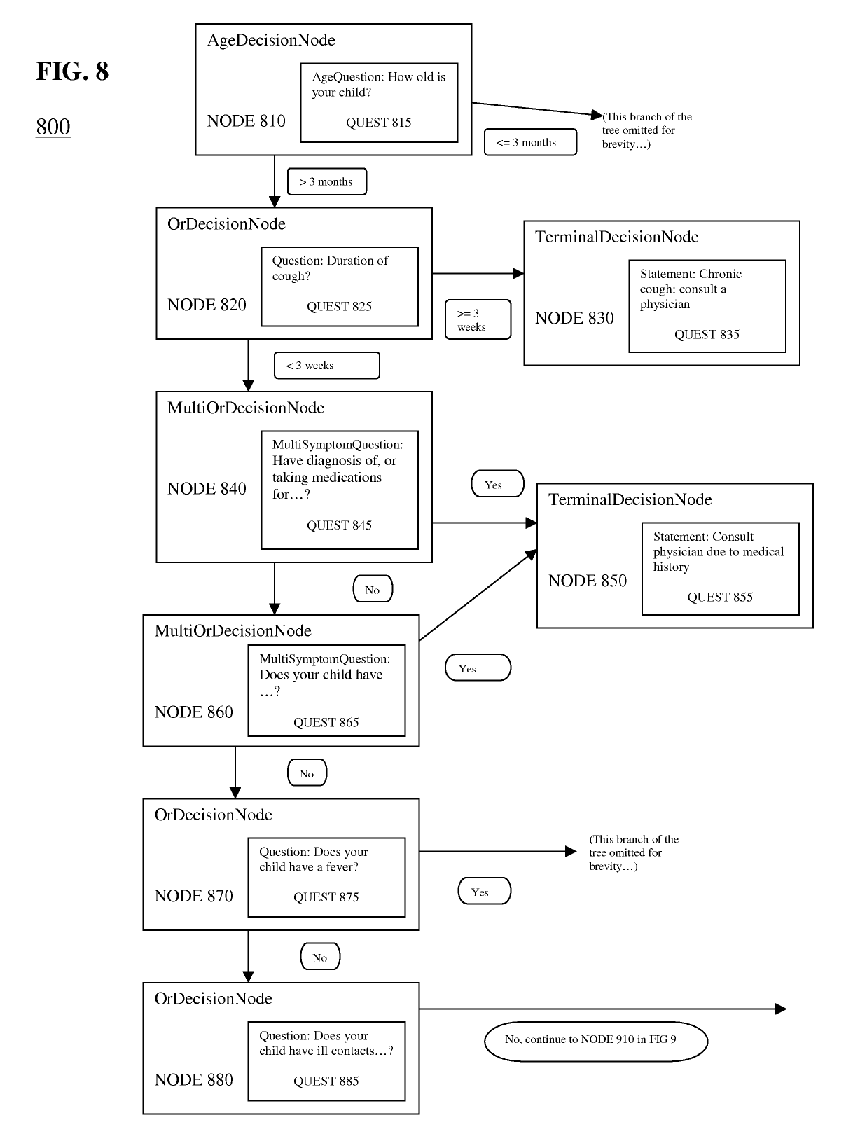

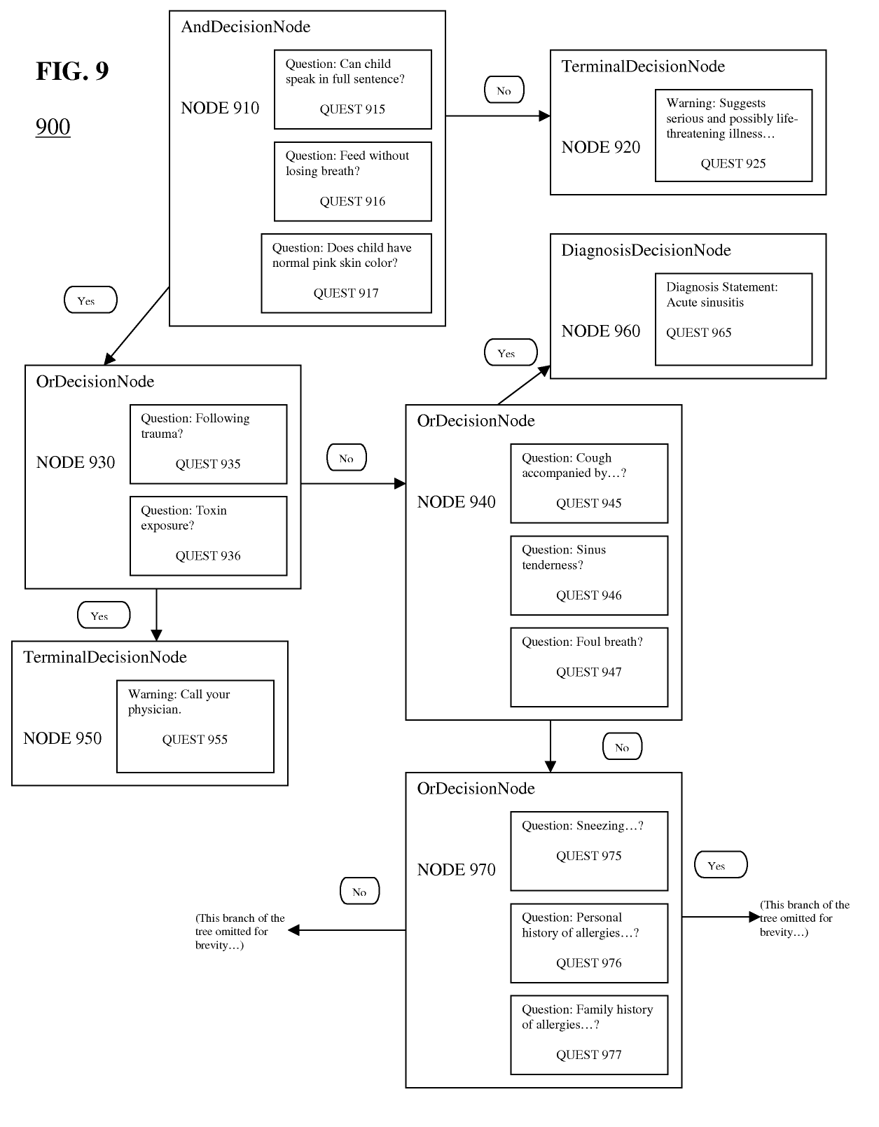

FIG. 8 and FIG. 9. together show how part of the cough algorithm from FIG. 3 and FIG. 4 is represented by DiagnosisNodes and Questions, in accordance with an embodiment. DiagnosisNodes are labeled with the name of the DiagnosisNode subclass and NODE X, where X is a unique number. Questions are labeled with the name of the Question subclass and QUEST X, where X is a unique number. With reference to FIG. 8 and FIG. 3, NODE 810 represents the decision point labeled STEP 310, NODE 820 represents the decision point labeled STEP 320, NODE 830 represents the terminal point labeled TERMINAL 325, NODE 840 represents the decision point labeled 330, NODE 850 represents the terminal point labeled TERMINAL 335, NODE 860 represents the decision point labeled STEP 340, NODE 870 represents the decision point labeled STEP 350, and NODE 880 represents the decision point labeled STEP 360.

With reference to FIG. 9 and FIG. 4, NODE 910 represents the decision point labeled STEP 410, NODE 920 represents the terminal point labeled TERMINAL 415, NODE 930 represents the decision point labeled STEP 420, NODE 940 represents the decision point labeled STEP 430, NODE 950 represents the terminal point labeled TERMINAL 425, NODE 960 represents the terminal point labeled TERMINAL 435, and NODE 970 represents the decision point labeled STEP 440.

In one or more embodiments, a component of the system called the Diagnosis Engine runs the diagnosis. The diagnosis engine runs a depth-first traversal of the diagnosis algorithm, using a “to-visit” stack of decision nodes. Each non-terminal Decision Node pushes one or more Decision Nodes onto the to-visit stack or diagnosis queue. The actual nodes pushed depend on the answers given by the user to the questions associated with the decision node. DecisionNodes that are DiagnosisNodes are pushed onto the diagnosis queue. All others are pushed onto the to-visit stack. The diagnosis queue allows the Diagnosis Engine to collect multiple possible diagnoses to display to the user simultaneously after the algorithm terminates. There are two ways for the traversal to terminate. If a TerminalDecisionNode is reached, the algorithm terminates immediately, even if there are nodes remaining in the to-visit stack. This method of termination allows the algorithm to stop immediately if it detects a medical emergency or decides on a single recommendation or diagnoses. The other method of termination is if the to-visit stack is empty. If the to-visit stack is empty, the diagnoses associated with the DiagnosisNodes in the diagnosis queue are displayed for the user. This method of termination allows multiple possible diagnoses to be displayed for the user.

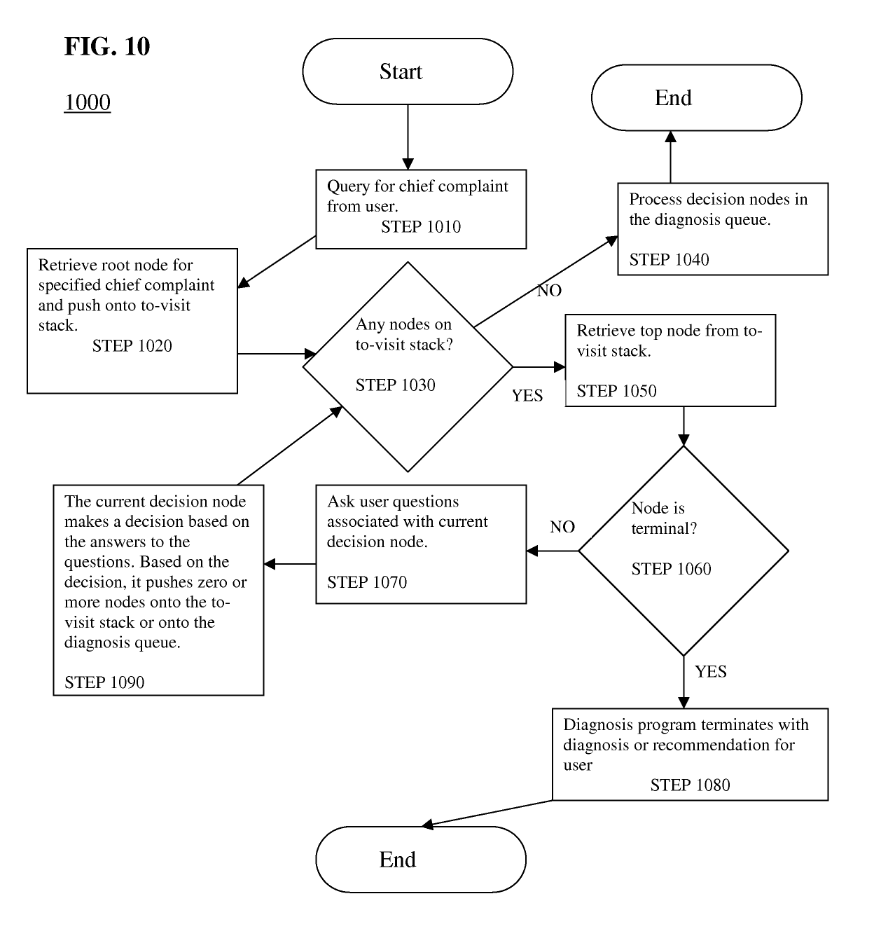

FIG. 10 shows a flow chart for the execution of a single diagnosis algorithm by the Diagnosis Engine in accordance with one or more embodiments of the invention. The steps of the Diagnosis Engine are described with reference to FIG. 10. In step 1010, the Diagnosis Engine initiates a diagnosis by querying for the chief complaint from the user. The Diagnosis Engine, in step 1020, retrieves from the diagnosis algorithm database the root decision node for the algorithm representing that chief complaint and pushes it onto the to-visit stack. The Diagnosis Engine then does a depth-first traversal using the to-visit stack. The Diagnosis Engine checks the stack in STEP 1030. If there are no more nodes, it prints the diagnoses in the Diagnosis Queue, in STEP 1040. Otherwise, it retrieves the top node in the to-visit stack in STEP 1050. If the node is terminal, in STEP 1060, then the diagnosis engine displays the information associated with that terminal decision node in STEP 1080 and terminates the algorithm. Otherwise, the Diagnosis Engine asks the user the questions associated with the decision node in STEP 1070. In STEP 1090 the Diagnosis Engine processes the answers to the questions, and depending on the answers, pushes nodes onto the to-visit stack or diagnosis queue. The Diagnosis Engine then returns to step 1030.

### Variations

In one or more embodiments of the invention, the Diagnosis Engine stores the answer to each question. If the same question arises again in the process of diagnosing the patient, which can happen if the execution jumps from one algorithm to another, the Diagnosis Engine skips that question, substituting the previously stored answer instead.

In one or more embodiments of the invention, the Diagnosis Engine can “auto-fill” answers to diagnosis algorithm questions from the user's electronic medical record.

In one or more embodiments of the invention, the Diagnosis Engine maintains a “visited” stack in addition to a “to-visit” stack. This enhancement allows the algorithm to work in reverse, giving the user the option to back-up at any point to a previous decision point.

In one or more embodiments of the invention, the medical database contains “triggers” in addition to diagnosis algorithms. These triggers are checked by the Diagnosis Engine based on the answers to the questions in a diagnosis algorithm, but are independent of any particular diagnosis algorithm. They can be used to catch conditions and emergencies that are categorically true, independent of the chief complaint and algorithm at hand.

What is claimed is:

1. A method for computer-assisted diagnosis, the method comprising:
encoding medical diagnosis algorithms as diagnosis decision trees (“diagnosis algorithms”), each comprising:
one chief complaint;
one or more decision points comprising zero or more questions; and
one or more termination points;
a user initiating the diagnosis by identifying a chief complaint;
the user traversing the diagnosis algorithm for that chief complaint, wherein the user answers a series of questions; and
the user receiving a diagnosis, conclusion, or recommendation.

2. The method of claim 1, further comprising the lack of interaction, either directly or indirectly, of the user with a live physician.

3. The method of claim 1, further comprising diagnosis algorithm questions on the subjects of current symptoms, medical history, and identification (age, sex, race).

4. The method of claim 1, further comprising diagnosis algorithm decision points based on age, symptom presence, symptom duration, medical history, physical finding, general history, symptom details, and family history.

5. The method of claim 1, further comprising diagnosis algorithm termination points for diagnoses, recommendations for home treatment, recommendations to see a physician, and recommendations to visit an emergency room.

6. The method of claim 1, wherein a diagnosis algorithm for one chief complaint may reference a diagnosis algorithm for a different chief complaint such that the user traversing the first algorithm at a certain decision point automatically begins traversing the second.

7. The method of claim 1, wherein the answers to user questions can be “auto-filled” from previous stored user answers or from the user's associated electronic medical record.

8. An apparatus for computer-assisted diagnosis, the apparatus comprising:
medical diagnosis algorithms encoded in computer-readable media as diagnosis decision trees (“diagnosis algorithms”) each comprising:
one chief complaint;
one or more decision points comprising zero or more questions; and
one or more termination points;
an interface for a user to initiate a diagnosis by identifying a chief complaint;
an interface for the user to traverse the diagnosis algorithm for that chief complaint, wherein the user answers a series of questions; and
an interface for the user to receive a diagnosis, conclusion, or recommendation.

9. The apparatus of claim 8, wherein the user interacts with the system over the Internet by using a web browser.

10. The apparatus of claim 8, wherein the diagnosis algorithms are stored as XML-structured text in a relational database.

11. The apparatus of claim 8, wherein the diagnosis algorithms and diagnosis traversal logic are implemented in an object-oriented programming language, further comprising:
distinctly separate object abstractions for the decision points of the diagnosis algorithms and the questions asked at those decision points;
the question abstraction handling the details of formatting a question and response, and processing the user's answer; and
the decision node abstraction handling the logic of the decision points, each of which may depend on the answers to zero or more questions.

12. The apparatus of claim 11, further comprising:
a Question superclass, whose interface is comprised of methods to generate a question and response in the proper format, to parse the user's answer, and to translate the answer into a result that the rest of the diagnosis program can use; and
subclasses (subtypes) of the Question superclass comprising abstractions for asking the user's age, displaying a non-terminal statement, displaying a diagnosis, asking about multiple symptoms/diseases/diseases history being present, displaying a terminal statement, and displaying a severe terminal statement (warning).

13. The apparatus of claim 12, further comprising;
a DecisionNode superclass to represent the decision points in the diagnosis algorithms in which each DecisionNode has zero branches (terminal), one branch (unary), two branches (binary), or more than two branches (n-ary);
each branch of a DecisionNode points to one or more DecisionNodes;
each DecisionNode object is associated with one or more Questions;
subclasses (subtypes) of the DecisionNode superclass comprise abstractions for age decision points, conjunction (“and”) decision points, disjunction (“or”) decision points, disjunction decision points pointing to multiple decision points to be taken sequentially, binary decision points, and terminal decision points;
each algorithm is a directed acyclic graph (DAG) of DecisionNode objects; and
each algorithm contains one root node.

14. The apparatus of claim 13, further comprising;
a “to-visit” stack of decision nodes;
a “diagnosis” queue of decision nodes;
initiating the algorithm by pushing the root node for that algorithm on the to-visit stack;
a “diagnosis engine” that runs a depth-first traversal of the diagnosis algorithm by popping and executing the top node in the to-visit stack;
executing a decision node results in zero or more decision nodes being pushed on the to-visit stack and zero or more decision nodes being pushed on the diagnosis queue;
the diagnosis engine terminates if it comes across a terminal decision node; and
when the to-visit stack is empty, the diagnosis engine terminates and displays the diagnosis nodes in the diagnosis queue.

15. The apparatus of claim 14, further comprising a “visited” stack of decision nodes to allow the diagnosis engine to work in reverse to give the user to option to back up and answer a question differently.

16. The apparatus of claim 14, further comprising “auto-filling” answers to questions from previous stored user answers or from user's associated electronic medical record.

17. The apparatus of claim 14, further comprising triggers that are independent of the diagnosis algorithms, and that are checked by the diagnosis engine based on the answers to user questions.
